(19) United States
(12) Patent Application Publication
(10) Pub. No.: US 2026/0075183 A1
(43) Pub. Date: Mar. 12, 2026

(54) METHOD AND DEVICE FOR VIDEO CODING USING TEMPLATE-BASED PREDICTION

(71) Applicants: HYUNDAI MOTOR COMPANY, Seoul (KR); KIA CORPORATION, Seoul (KR); KWANGWOON UNIVERSITY INDUSTRY-ACADEMIC COLLABORATION FOUNDATION, Seoul (KR)

(72) Inventors: Dong Gyu Sim, Seoul (KR); Min Hun Lee, Uijeongbu-si (KR); Han Sol Choi, Dongducheon-si (KR); Jin Heo, Yongin-si (KR); Seung Wook Park, Yongin-si (KR)

(73) Assignees: HYUNDAI MOTOR COMPANY, Seoul (KR); KIA CORPORATION, Seoul (KR); KWANGWOON UNIVERSITY INDUSTRY-ACADEMIC COLLABORATION FOUNDATION, Seoul (KR)

(21) Appl. No.: 19/101,178

(22) PCT Filed: Jul. 5, 2023
(86) PCT No.: PCT/KR2023/009492

§ 371 Date: Feb. 4, 2025

(30) Foreign Application Priority Data
Aug. 9, 2022 (KR) 10-2022-0099346
Jul. 4, 2023 (KR) 10-2023-0086439

(51) Int. Cl. H04N 19/105; H04N 19/176; H04N 19/196

(52) U.S. Cl. CPC H04N 19/105; H04N 19/176; H04N 19/196

(57) ABSTRACT

A method and an apparatus are disclosed for video coding using template-based prediction. In the disclosed embodiments, a video decoding device decodes a distance index (adjacent_idx) that indicates a distance between the current block and a template region. The video decoding device determines the template region based on the distance between the current block and the template region, and a shape of the template region. The video decoding searches for an optimal template in a search region by using the template region and based on template matching and generates a prediction block of the current block from a reference block corresponding to the optimal template.

### TECHNICAL FIELD

The present disclosure relates to a video coding method and an apparatus using template-based prediction.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

A template matching-based prediction selects as templates a plurality of reconstructed samples neighboring the current block, and then uses the selected templates to detect or search for the template that is most similar, i.e., that has the optimal loss value within the reconstructed region of the current block. The template matching-based prediction generates the prediction block of the current block from the reference block corresponding to the best template detected. The template matching-based prediction can use loss functions such as sum of absolute differences (SAD), mean squared error (MSE), sum of absolute transformed differences (SATD), or the like. to measure the similarity between the current block's template and the candidate templates in the reconstructed region. Regarding the current block, the encoder may signal a 1-bit flag indicating whether to use template matching-based prediction, and the decoder may parse the flag and search for a template with an optimal loss value following the same method as the encoder, and may use the optimal template to generate a prediction block of the current block.

When the template matching-based prediction is performed as described above, the adjacent region to the current block is utilized as the template of the current block. Therefore, to increase the video coding efficiency and enhance the video quality, a measure is needed for efficiently utilizing the neighboring samples of the current block.

### DISCLOSURE

### Technical Problem

The present disclosure seeks to provide a video coding method and an apparatus for setting an adjacent or non-adjacent region as a template according to information of a neighboring reconstructed region of a current block. The video coding method and the apparatus reconstruct the current block by performing a template matching-based prediction that is based on the set template.

### Technical Solution

At least one aspect of the present disclosure provides a method of reconstructing a current chroma block by a video decoding device. The method includes decoding from a bitstream a distance index (adjacent_idx) that indicates a distance between the current block and a template region. The method also includes determining the template region based on the distance between the current block and the template region, and a shape of the template region. The method also includes searching for an optimal template in a search region by using the template region and based on template matching. Here, the search region is defined within a reconstructed region of the current block. The method also includes generating a prediction block of the current block from a reference block corresponding to the optimal template.

Another aspect of the present disclosure provides a method of encoding a current block by a video encoding device. The method includes determining a distance index (adjacent_idx) that indicates a distance between the current block and a template region. The method also includes determining the template region based on the distance between the current block and the template region, and a shape of the template region. The method also includes searching for an optimal template in a search region by using the template region and based on template matching. Here, the search region is defined within a reconstructed region of the current block. The method also includes generating a prediction block of the current block from a reference block corresponding to the optimal template.

Yet another aspect of the present disclosure provides a computer-readable recording medium storing a bitstream generated by a video encoding method. The video encoding method includes determining a distance index (adjacent_idx) that indicates a distance between a current block and a template region. The video encoding method also includes determining the template region based on the distance between the current block and the template region, and a shape of the template region. The video encoding method also includes searching for an optimal template in a search region, by using the template region and based on template matching. Here, the search region is defined within a reconstructed region of the current block. The video encoding method also includes generating a prediction block of the current block from a reference block corresponding to the optimal template.

### Advantageous Effects

As described above, the present disclosure provides a video coding method and an apparatus for setting an adjacent or non-adjacent region as a template according to information of a neighboring reconstructed region of a current block. The video coding method and the apparatus reconstruct the current block by performing a template matching-based prediction that is based on the set template. Thus, the video coding method and the apparatus increase video coding efficiency and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a block diagram detailing a portion of a video decoding device, according to at least one embodiment of the present disclosure.

FIG. 7 is a diagram illustrating a template region of a current block, according to at least one embodiment of the present disclosure.

FIGS. 8A through 8C are diagrams illustrating the locations and shapes of template regions of the current block, according to some embodiments of the present disclosure.

FIGS. 9A and 9B are diagrams illustrating a directional intra-prediction mode.

FIG. 10 is a flowchart of a prediction method for the current block performed by a video decoding device, according to at least one embodiment of the present disclosure.

FIG. 11 is a flowchart of a prediction method of the current block performed by the video decoding device, according to another embodiment of the present disclosure.

FIG. 12 is a diagram illustrating an initial template region according to at least one embodiment of the present disclosure.

FIG. 13 is a diagram illustrating a final template region according to at least one embodiment of the present disclosure.

FIGS. 14A and 14B are diagrams illustrating a final template region according to other embodiments of the present disclosure.

FIG. 15 is a flowchart of a prediction method for the current block performed by a video encoding device, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

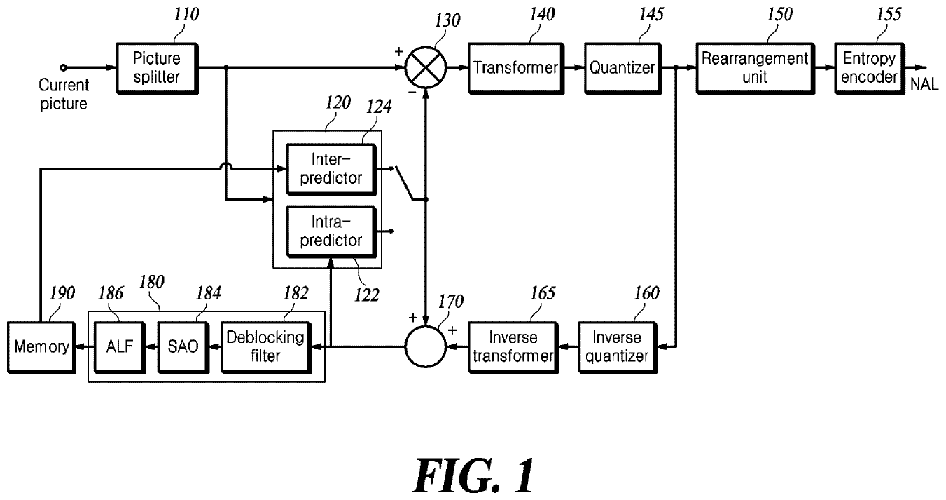

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

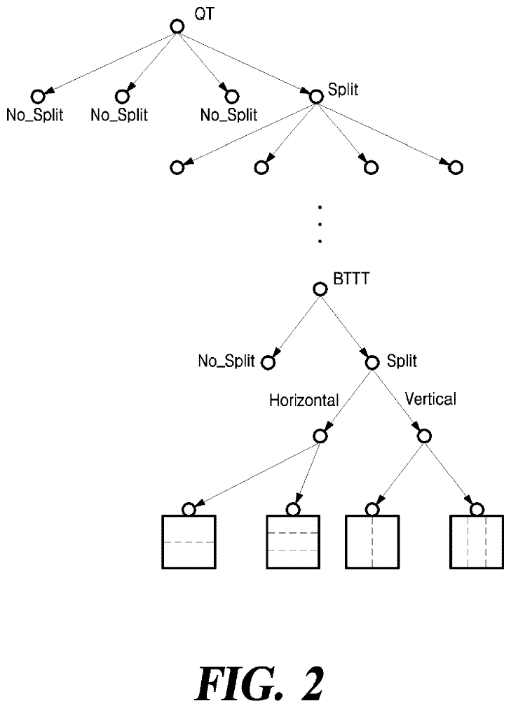

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

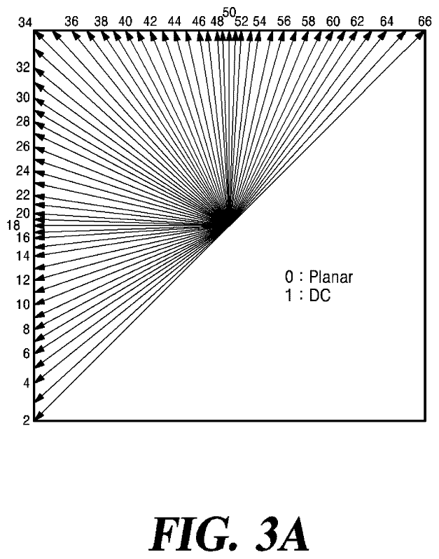

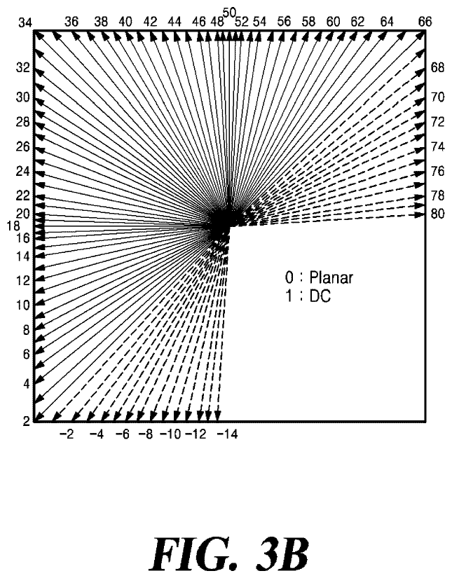

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #-1 to #-14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode.

Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

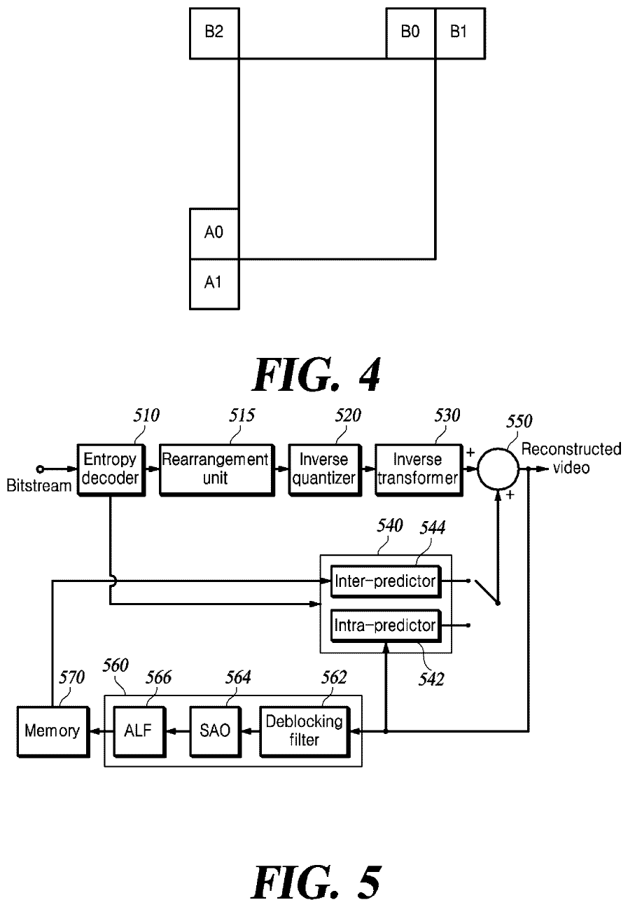

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding device may store a bitstream of encoded video data in a non-transitory storage medium or transmit the bitstream to the video decoding device through a communication network.

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus for setting an adjacent or non-adjacent region as a template according to information of a neighboring reconstructed region of a current block. The video coding method and the apparatus reconstruct the current block by performing a template matching-based prediction that is based on the set template.

The following embodiments may be performed by the predictor 120 in the video encoding device. The following embodiments may also be performed by the predictor 540 in the video decoding device.

The video encoding device in encoding the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the decoding of the current block.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

The following embodiments are described with respect to the video decoding device but may be implemented the same or similarly in the video encoding device.

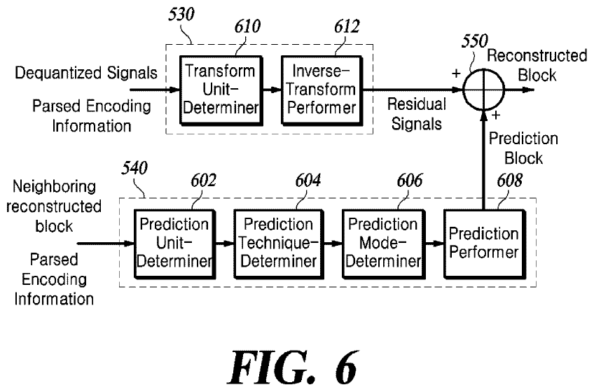

FIG. 6 is a block diagram detailing a portion of a video decoding device, according to at least one embodiment of the present disclosure.

The video decoding device according to some embodiments can determine prediction unit and transform unit, and for to a current block corresponding to the determined unit, perform a prediction and an inverse transform by using a determined prediction technique and prediction mode, to finally generate a reconstructed block of the current block. The operations illustrated in FIG. 6 may be performed by an inverse transformer 530, a predictor 540, and an adder 550 of the video decoding device. On the other hand, the same operations as illustrated in FIG. 6 may be performed by the inverse transformer 165, the picture splitter 110, the predictor 120, and the adder 170 of the video encoding device. In this case, the video decoding device uses encoding information parsed from the bitstream, but the video encoding device may use encoding information set from a higher level in terms of minimizing rate distortion. Hereinafter, for convenience, the embodiments are described centering on the video decoding device.

As illustrated in FIG. 5, the predictor 540 includes the intra predictor 542 and the inter predictor 544, depending on the prediction technique, but as illustrated in FIG. 6, the predictor 540 may include all or part of a prediction unit-determiner 602, a prediction technique-determiner 604, a prediction mode-determiner 606, and a prediction performer 608.

When the color format of the input video is a YUV format (YUV420, YUV411, YUV422, YUV444, etc.), the video decoding device may perform prediction and reconstruction of the luma component and then may perform prediction and reconstruction of the chroma component. In other words, the luma component and the chroma component may be sequentially reconstructed by the components illustrated in FIG. 6. On the other hand, when the color format of the input video is RGB, the video encoding device may perform a color format transform from RGB to YUV, and then may encode the transformed video. Here, in the case of the YUV format, the color format represents a corresponding relation between pixels in the luma component and pixels in the chroma component.

The prediction unit-determiner 602 determines a prediction unit (PU). The prediction technique-determiner 604, with respect to the prediction unit, determines a prediction technique, e.g., intra prediction, inter prediction, or intra block copy (IBC) mode, palette mode, template-based prediction, or the like. The prediction mode-determiner 606 determines a detailed prediction mode for the prediction technique. The prediction performer 608 generates a prediction block of the current block according to the determined prediction mode.

The inverse transformer 530 includes a transform unit-determiner 610 and an inverse transform-performer 612. The transform unit-determiner 610 determines a transform unit (TU) in response to the inverse quantization signals of the current block, and the inverse transform-performer 612 inversely transforms the transform unit represented by the inverse quantization signals to generate residual signals.

The adder 550 sums the prediction block and the residual signals to generate a reconstructed block. The reconstructed block is stored in memory and may be used for predicting other blocks in the future.

The prediction unit determined by the prediction unit-determiner 602 may become the current block or one subblock of the subblocks split from the current block. In this case, the prediction unit of the chroma component may correspond in size to the prediction unit of the luma component, depending on the color format. Alternatively, the prediction units of the luma component and the chroma component may be determined separately, and the prediction may be performed for the prediction unit of the chroma component.

The prediction technique-determiner 604 determines a prediction technique for the prediction units. As described above, the prediction technique may be one of inter prediction, intra prediction, IBC mode, palette mode, and template-based prediction. In this case, the prediction technique of the chroma component may be determined to be the same as the prediction technique of the corresponding luma component without signaling and parsing separate information.

When the prediction technique of the current block is intra prediction, the prediction mode-determiner 606 may determine the template-based prediction as the prediction mode by signaling and parsing the 1-bit flag.

As another example, the prediction mode-determiner 606 may use the signaling and parsing of the 1-bit flag to determine the prediction technique and prediction mode of the current block as the template-based prediction.

As yet another example, when the prediction technology of the current block is inter prediction, the prediction mode-determiner 606 may utilize template matching in response to the prediction signals obtained based on the initial movement information. The video decoding device may utilize the template matching to correct the motion information of the initial prediction signals, and then may use the corrected motion information to generate the final prediction signals.

The following describes the operation of the prediction performer 608 with respect to template matching-based prediction. Hereinafter, the video decoding device refers to the prediction performer 608.

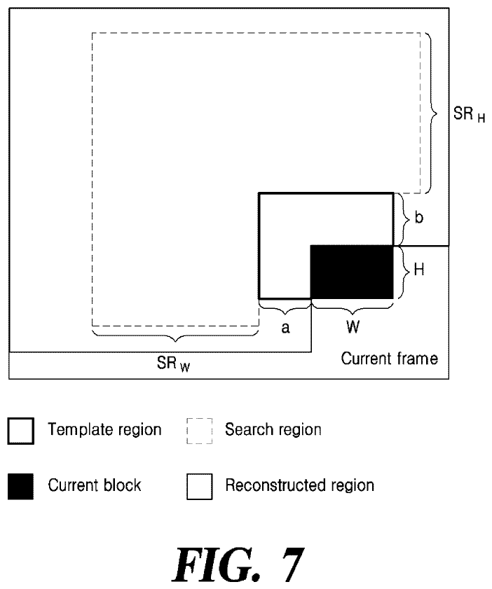

FIG. 7 is a diagram illustrating a template region of the current block, according to at least one embodiment of the present disclosure.

As an example, a case is described where a prediction technique of a current block having a size W×H (W is a block width and H is a block height) is intra prediction, and a template-based prediction is determined in place of the prediction mode by signaling and parsing a 1-bit flag (hereinafter referred to as a ‘template matching flag’). The video decoding device sets as a template the neighboring reconstructed region of the current block, as illustrated in FIG. 7, and uses the set template to perform template matching on the reconstructed region in the current frame, to search for a template having an optimal loss value. The video decoding device may generate prediction signals of the current block from a reference block corresponding to the detected optimal template. Template matching is a process of calculating the similarity between the template of the current block and the candidate templates in the reconstructed region to detect the template with the optimal similarity between their pixels, i.e., with the optimal loss value. The similarity may be calculated based on a loss function. The video decoding device may use as the loss function one of the methods of calculating the similarity between pixels, such as mean squared error (MSE), sum of absolute differences (SAD), sum of absolute transformed differences (SATD), or the like. Meanwhile, the relationship between the current block and the template corresponds to the relationship between the reference block and the detected optimal template.

As another example, in template matching based on a loss function, the video decoding device may search for N (a natural number) templates in order of increasing loss value. The video decoding device may weight sum the reference blocks corresponding to the detected N templates to generate a final prediction signal of the current block.

In the example of FIG. 7, W and H represent the width and height of the current block, respectively.

In the example of FIG. 7, the template region is L-shaped. Along with W and H, ‘a’ and ‘b’ define the size of the template region. ‘a’ represents the bottom width of the template region on the left side of the current block, and ‘b’ represents the right height of the template region on the top side of the current block. In this case, ‘a’ and ‘b’ may be implicitly determined based on the size of the current block. Alternatively, ‘a’ and ‘b’ may be fixed values regardless of the size of the current block.

In the example of FIG. 7, SR_{W} and SR_{H} define the size of the search region. SR_{W} represents the bottom width of the search region on the left side of the current block, and SR_{H} represents the right height of the search region on the top side of the current block. As illustrated in FIG. 7, the search region is defined within the reconstructed region of the current block and may be all or part of the reconstructed region. The SR_{W} and SR_{H} may be implicitly determined based on the size of the current block. Alternatively, the SR_{W} and SR_{H} may be implicitly determined based on the resolution of the input video. Yet alternatively, SR_{W} and SR_{H} may be fixed values irrespective of the size of the current block.

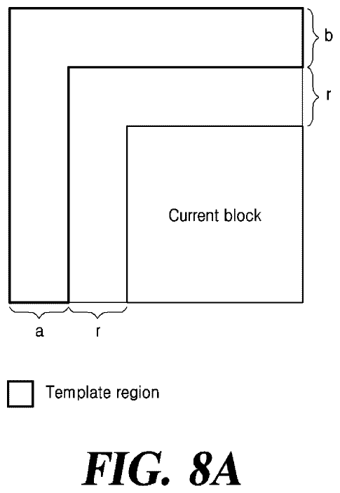

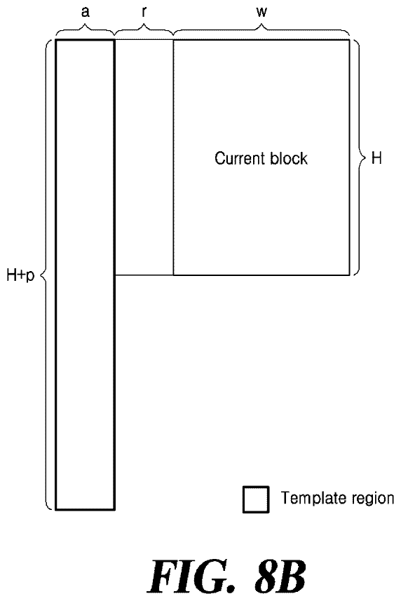

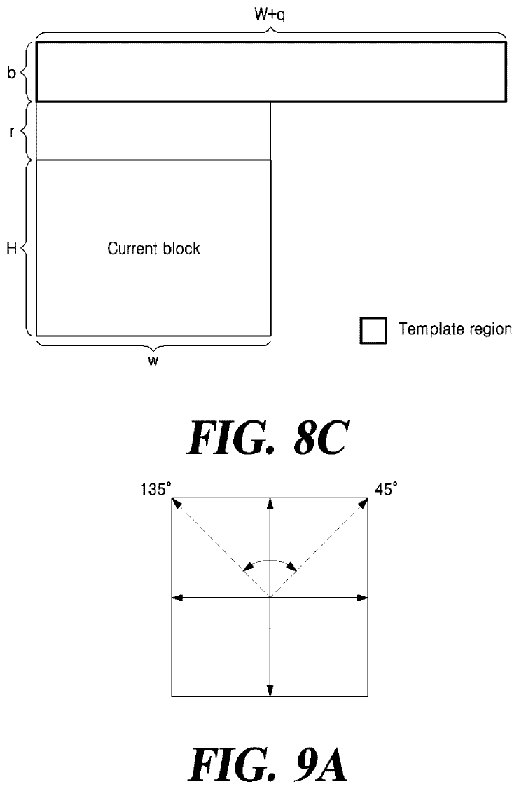

FIGS. 8A through 8C are diagrams illustrating the locations and shapes of template regions of the current block, according to some embodiments of the present disclosure.

Hereinafter, ‘position and shape of the template region’ and ‘shape of the template region’ are used interchangeably, as the position of the template region may also determine the shape of the template.

As another example, a template region for template matching-based prediction may be determined as an adjacent or non-adjacent reconstructed region to the top-and-left of the current block, to the left of the current block, or to the top of the current block, as illustrated FIGS. 8A to 8C. As in the example of FIG. 8A, when the template region is present on the top-and-left of the current block, the template region is L-shaped. In the example of FIG. 8A, the template region may be defined based on the width and height (W, H) of the current block, the bottom width ‘a’ of the template region present on the left of the current block, the right height ‘b’ of the template region present on the top of the current block, and the distance ‘r’ between the current block and the template region.

Further, when the template region is present on the left side of the current block, as in the example of FIG. 8B, the template region has a rectangular shape. In the example of FIG. 8B, the template region has a width of ‘a’ and a height of H+p (where ‘p’ is an integer). ‘p’ represents the difference between the height of the template region and the height of the current block. When the template region is present at the top of the current block, as illustrated in FIG. 8C, the template region has a rectangular shape. In the example of FIG. 8C, the template region has a width of W+q (where ‘q’ is an integer) and a height of ‘b’. ‘q’ represents the difference between the width of the template region and the width of the current block.

Here, W, H, a, b, p, q, and r are values in pixels.

As described above, in the examples of FIGS. 8A through 8C, ‘r’ represents the distance between the current block and the template region. ‘p’ and ‘q’ may be implicitly determined based on the size of the current block, or the aspect ratio of the current block. Alternatively, ‘p’ and ‘q’ may be fixed values. Additionally, ‘r’ may be signaled and parsed in the form of an index (hereinafter, ‘distance index, adjacent_idx’).

In one example, the video decoding device may parse an index that indicates the shape of the template region. Based on the parsed index, the video decoding device may determine the shape of the template region to be present on or around the top-and-left of the current block, the left of the current block, or the top of the current block, as shown in FIGS. 8A through 8C. Finally, the video decoding device may set the distance value ‘r’ based on the parsed distance index to determine the template region of the current block.

As another example, the video decoding device may implicitly determine the template region based on an aspect ratio of the current block having a size W×H. For example, if W=H, the top-and-left region of the current block may be determined as the template region, as illustrated in FIG. 8A. If W<H, the left region of the current block may be determined as the template region, as illustrated in FIG. 8B. If W >H, the top region of the current block may be determined as the template region, as illustrated in FIG. 8C. Finally, the video decoding device may set the distance value ‘r’ according to the parsed distance index to determine the template region of the current block.

On the other hand, with respect to the chroma block, the video decoding device may implicitly determine the location and shape of the template region according to the prediction mode of a luma block co-located with the chroma block (hereinafter, the ‘corresponding luma block’).

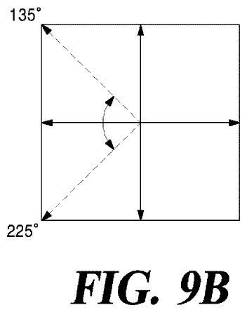

In one example, if the prediction mode of the center region of the corresponding luma block is an intra-prediction mode which is a directional prediction mode between 45 degrees and 135 degrees, as illustrated in FIG. 9A, the video decoding device may determine the reconstructed top region of the current chroma block as the template region, as illustrated in FIG. 8C.

If the prediction mode of the center region of the corresponding luma block is an intra-prediction mode which is a directional prediction mode between 135 degrees and 225 degrees, as illustrated in FIG. 9B, the video decoding device may determine the reconstructed left region of the current chroma block as the template region, as illustrated in FIG. 8B.

Alternatively, if the prediction mode of the center region of the corresponding luma block is an intra-prediction mode which is a planar mode or a DC mode, the video decoding device may determine the reconstructed top-and-left region of the current chroma block as the template region, as illustrated in FIG. 8A.

Finally, the video decoding device may set the distance value ‘r’ based on the parsed distance index or by directly parsing the distance value ‘r’ to determine the template region of the current chroma block.

As another example, with respect to the chroma block, the video decoding device may implicitly determine a distance between the current chroma block and the template region based on a distance from a non-adjacent reference line at the top-and-left boundary region of the corresponding luma block.

For example, if the color format of the input video is YUV420, and the top-and-left boundary region of the corresponding luma block is predicted from non-adjacent reference lines at distances k and m, respectively, the video decoding device may determine as k>>1 the distance between the current chroma block and the left template region, and implicitly determine as m>>1 the distance between the current chroma block and the top template region. Thus, the video decoding device may adjust the distance between the current chroma block and the template region according to the color format of the input video.

As another example, a case is described where, for a chroma block, a single tree structure is used and its corresponding luma block is predicted according to a prediction mode based on template matching. Here, in the single tree structure, the luma component and the chroma component have the same block partitioning structure. If the sampling is different between the luma component and the chroma component according to the color format of the input video, the video decoding device may determine the template region of the chroma component by sampling a template region corresponding to the template region of the luma component.

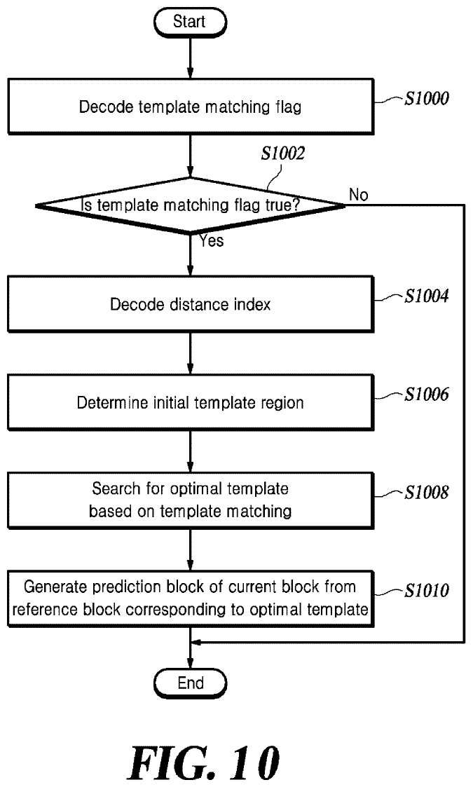

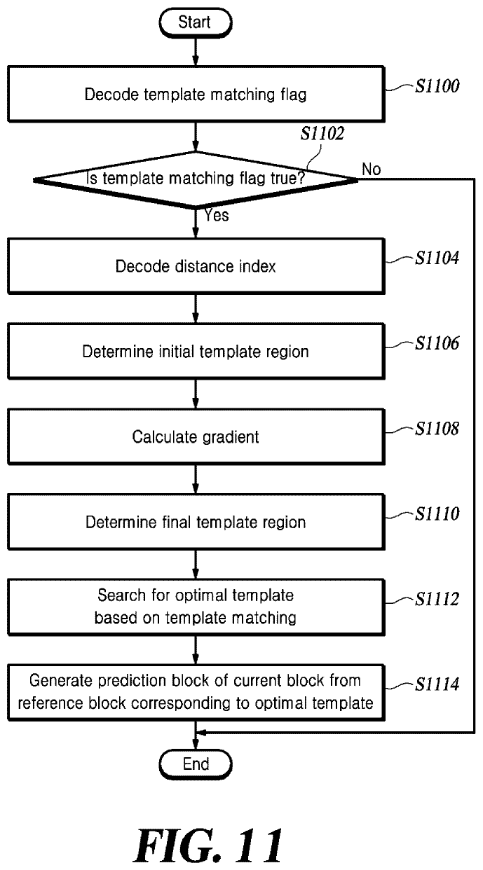

Meanwhile, according to the flowcharts illustrated in FIGS. 10 and 11, the video decoding device may determine a template region of the current block, and perform a template matching-based prediction based on the determined template region.

FIG. 10 is a flowchart of a prediction method for the current block performed by the video decoding device, according to at least one embodiment of the present disclosure.

The video decoding device decodes a template matching flag from the bitstream (S1000). Here, the template matching flag indicates whether to use a prediction mode based on template matching when the prediction technique of the current block is intra prediction or template-based prediction.

The video decoding device checks the template matching flag (S1002).

If the template matching flag is true (Yes in S1002), the video decoding device may perform steps (S1004 through S1008) related to template matching.

The video decoding device decodes a distance index from the bitstream (S1004).

Based on the distance index (adjacent_idx), the video decoding device may determine a distance ‘r’ between the current block and the template region. The video decoding device may also determine the size of the template region by using the fixed or implicitly determined ‘a’ and ‘b’.

Meanwhile, the distance index may be defined by a lookup table as agreed between the video encoding device and the video decoding device. Alternatively, if a non-adjacent region-based intra-prediction mode is applicable in the video encoding device, the template matching-based prediction may share the distance index lookup table used for the non-adjacent region-based intra prediction with the non-adjacent region-based intra prediction. Here, the non-adjacent region-based intra prediction utilizes non-adjacent reference lines based on, for example, multiple reference line (MRL).

The video decoding device determines an initial template region (S1006). The video decoding device may determine the initial template region based on the distance ‘r’ and the size of the template region, as illustrated in FIGS. 8A to 8C.

By using the initial template region, the video decoding device may search for an optimal template based on template matching (S1008). The video decoding device searches for a region with the optimal loss value in the search region of the current block.

The video decoding device generates a prediction block of the current block with a reference block corresponding to the detected optimal template (S1010).

On the other hand, if the template matching flag is false (No in S1002), the video decoding device may skip the steps related to template matching. For example, when the prediction technique is intra prediction, the video decoding device may generate a prediction block of the current block based on the parsed intra-prediction mode. Alternatively, when the prediction technique is not a template matching-based prediction, the video decoding device may generate the prediction block of the current block by using a different prediction technique and its accompanying prediction mode.

FIG. 11 is a flowchart of a prediction method of the current block performed by the video decoding device, according to another embodiment of the present disclosure.

The example of FIG. 11 commonly uses the steps of the decoding of the template matching flag (S1100) through the determining of the initial template region (S1106) as illustrated in FIG. 10, so described are their subsequent steps.

The video decoding device calculates a gradient (S1108).

The video decoding device determines a final template region by using the calculated gradient (S1110).

The video decoding device uses the final template region to search for an optimal template based on the template matching (S1112). The video decoding device searches for the region with the optimal loss value in the search region of the current block.

The video decoding device generates a prediction block of the current block with a reference block corresponding to the detected optimal template (S1114).

The following details steps of determining the final template region by using the gradient.

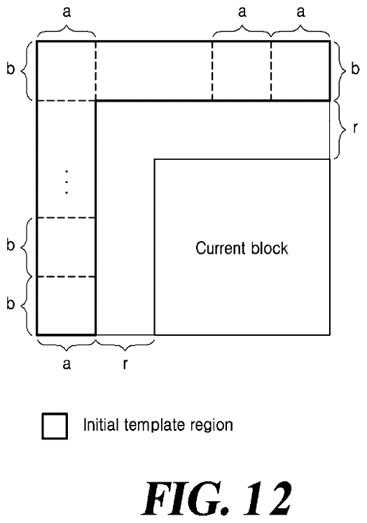

As one example, the video decoding device may partition the initial template region into subblocks having a size of a×b, as illustrated in FIG. 12, and then may calculate the directionality and size of the gradient for each subblock. For example, each subblock may have a size implicitly determined by the size of the current block or may have a preset size. The video decoding device may estimate the directionality and size of the gradient on a subblock-by-subblock basis by applying a differential filter to each subblock. The differential filter may be one of the filters, such as a Perwitt filter, a Roberts filter, or a Sobel filter, applied to the vertical and horizontal directions.

The video decoding device may apply a differential filter to the subblocks in the initial template region to calculate the gradients, dx and dy, in the horizontal and vertical directions. The video decoding device may calculate Grad_{mag}, the magnitude of the gradient per subblock, by using either Equation 1 or Equation 2.

$${Grad}_{mag} = \vert dx \vert + \vert dy \vert \qquad [ Equation 1 ]$$

$${Grad}_{mag} = \sqrt{{dx}^{2} + {dy}^{2}} \qquad [ Equation 2 ]$$

The video decoding device may also calculate Grad_{ang}, which is the directionality of the gradient per subblock, as shown in Equation 3.

$${Grad}_{ang} = \frac{dy}{dx} \qquad [ Equation 3 ]$$

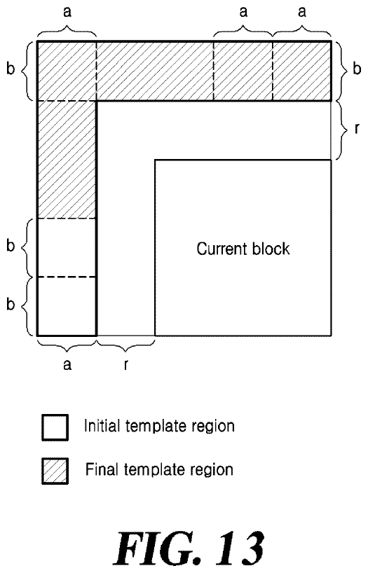

FIG. 13 is a diagram illustrating a final template region according to at least one embodiment of the present disclosure.

After calculating the magnitude and directionality of the gradient of each subblock, the video decoding device may generate a histogram of the magnitude or directionality of the gradient. Then, based on the directionality histogram of the gradient, the video decoding device may determine a region of the subblocks having the most frequent directionality as the final template region, as illustrated in FIG. 13. Additionally, the video decoding device may take account of the magnitude histogram of the gradient. For example, after first selecting subblocks having gradient magnitudes of a predetermined threshold or more, the video decoding device may reselect the subblocks with the most frequent directionality from the selected subblocks.

Alternatively, based on the directionality histogram of the gradient generated according to the process described above, the video decoding device may determine as the final template region the region of subblocks having directionality corresponding to a frequency of a predetermined threshold or higher, as illustrated in FIG. 13. Additionally, the video decoding device may take account of the magnitude histogram of the gradient. For example, after first selecting subblocks having gradient magnitudes of a predetermined threshold or more, the video decoding device may reselect subblocks having directionality corresponding to frequencies of the predetermined threshold or higher from the selected subblocks.

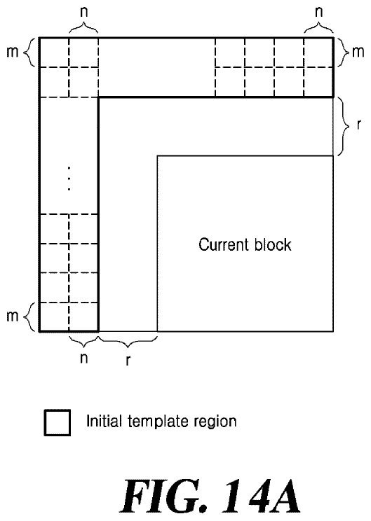

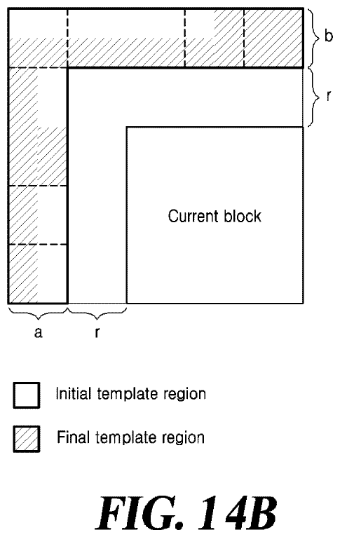

FIGS. 14A and 14B are diagrams illustrating a final template region according to other embodiments of the present disclosure.

As another example, the video decoding device may, after determining the initial template region, as illustrated in FIG. 12, partition the initial template region into subblocks having a size of n×m with an integer ‘n’ that is less than or equal to ‘a’, and an integer ‘m’ that is less than or equal to ‘b’, as illustrated in FIG. 14A. Thus, each subblock may have an implicitly determined size based on the size of the current block or may have a preset size. The video decoding device may calculate for each subblock the directionality and magnitude of the gradient by using Equation 1 to Equation 3, and generate a directionality histogram of the gradient. Then, based on the directionality histogram of the gradient, the video decoding device may determine a region of the subblocks having the most frequent directionality as the final template region, as illustrated in FIG. 14B.

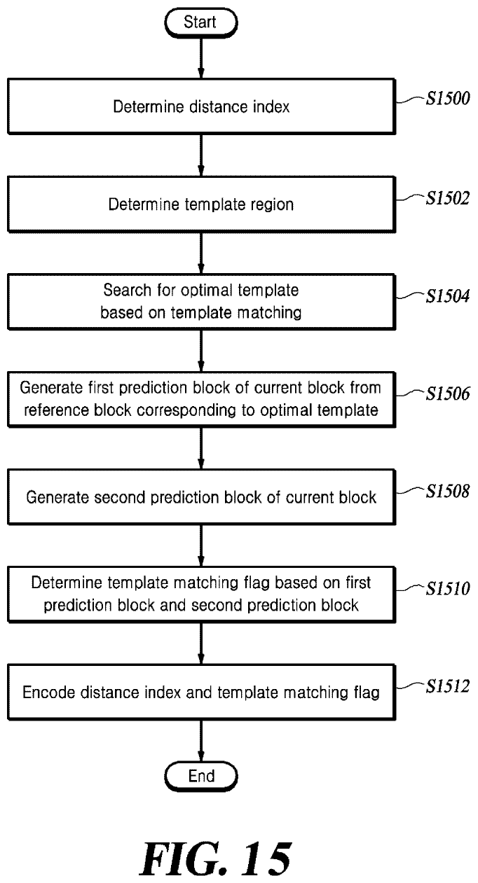

FIG. 15 is a flowchart of a prediction method for the current block performed by the video encoding device, according to at least one embodiment of the present disclosure.

The video encoding device determines a distance index (S1500).

Here, the distance index indicates the distance between the current block and the template region. The video encoding device may determine the distance index in terms of rate-distortion optimization. Alternatively, the video encoding device may obtain the distance index from a higher level.

The video encoding device determines the template region based on the distance between the current block and the template region, and the shape of the template region (S1502).

By using the template region, the video encoding device searches for an optimal template in a search region based on the template matching (S1504). Here, the search region may be defined within the reconstructed region of the current block.

The video encoding device generates a first prediction block of the current block from the reference block corresponding to the optimal template (S1506).

The video encoding device generates a second prediction block of the current block by using a different prediction technique (S1508).

For example, when the prediction technique is intra prediction, the video encoding device may generate the second prediction block based on the intra-prediction mode. Alternatively, when the prediction technique is not a template matching-based prediction, the video encoding device may generate the second prediction block by using a different prediction technique and its accompanying prediction mode.

The video encoding device determines a template matching flag based on the first prediction block and the second prediction block (S1510). The video encoding device may determine the template matching flag in terms of rate-distortion optimization. For example, when the first prediction block is optimal, the video encoding device sets the template matching flag to be true. Alternatively, when the second prediction block is optimal, the video encoding device may set the template matching flag to be false.

The video encoding device encodes the distance index and the template matching flag (S1512).

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

120: predictor
540: predictor
602: prediction unit-determiner
604: prediction technique-determiner
606: prediction mode-determiner
608: prediction performer

### CROSS-REFERENCE TO RELATED APPLICATIONS

This application claims priority to and the benefit of Korean Patent Application No. 10-2022-0099346 filed on Aug. 9, 2022, and Korean Patent Application No. 10-2023-0086439, filed on Jul. 4, 2023, the entire contents of each of which are incorporated herein by reference.

What is claimed is:

1. A method of reconstructing a current block by a video decoding device, the method comprising:
decoding from a bitstream a distance index (adjacent_idx) that indicates a distance between the current block and a template region;
determining the template region based on the distance between the current block and the template region, and a shape of the template region;
searching for an optimal template in a search region by using the template region and based on template matching, wherein the search region is defined within a reconstructed region of the current block; and
generating a prediction block of the current block from a reference block corresponding to the optimal template.

2. The method of claim 1, wherein the shape of the template region comprises:
an L-shape that is present on a top-and-left of the current block and is defined based on a width of the current block, a height of the current block, a bottom width of a template region present on a left of the current block, a right height of a template region present on a top of the current block, and the distance between the current block and the template region,
wherein the bottom width of the template region present on the left of the current block and the right height of the template region present on the top of the current block are implicitly determined or fixed values based on a size of the current block.

3. The method of claim 1, wherein the shape of the template region comprises:
a rectangular shape that is present on a left of the current block and is defined based on a width and a height of a template region present on the left of the current block,
wherein a difference between the height of the template region and a height of the current block is implicitly determined or a fixed value based on a size of the current block, and the width of the template region is implicitly determined or a fixed value based on the size of the current block.

4. The method of claim 1, wherein the shape of the template region comprises:
a rectangular shape that is present on a top of the current block and is defined based on a width and a height of a template region present on the top of the current block,
wherein a difference between the width of the template region and a width of the current block is implicitly determined or a fixed value based on a size of the current block, and the height of the template region is implicitly determined or a fixed value based on the size of the current block.

5. The method of claim 1, wherein determining the template region comprises:
decoding from the bitstream an index indicative of the shape of the template region; and
determining the shape of the template region based on the index.

6. The method of claim 1, wherein determining the template region comprises:
implicitly determining the shape of the template region based on an aspect ratio of the current block.

7. The method of claim 1, wherein determining the template region comprises:
implicitly determining, regarding a chroma block of the current block, a position and a shape of a template region of the chroma block according to a prediction mode of a co-located luma block with the chroma block.

8. The method of claim 1, wherein searching for the optimal template comprises:
searching through a natural number N of templates in order of increasing loss value of the templates due to the template matching.

9. The method of claim 8, wherein generating the prediction block comprises:
weight summing reference blocks corresponding to the N templates to generate the prediction block of the current block.

10. The method of claim 1, further comprising:
calculating a gradient of the template region; and
resetting the template region by using the gradient.

11. The method of claim 10, wherein calculating the gradient comprises:
dividing the template region into subblocks;
calculating a magnitude and directionality of the gradient for each of the subblocks; and
generating a directionality histogram of the gradient.

12. The method of claim 11, wherein each of the subblocks has a size implicitly determined by a size of the current block, or has a preset size.

13. The method of claim 11, wherein resetting the template region comprises:
determining as the template region a region of subblocks having a most frequent directionality based on the directionality histogram.

14. The method of claim 11, wherein resetting the template region comprises:
generating a magnitude histogram for the gradient;
selecting, based on the magnitude histogram, subblocks having gradient magnitudes equal to or greater than a preset threshold; and
determining, based on the directionality histogram, a region of selected subblocks having a most frequent directionality as the template region.

15. A method of encoding a current block by a video encoding device, the method comprising:
determining a distance index (adjacent_idx) that indicates a distance between the current block and a template region;
determining the template region based on the distance between the current block and the template region, and a shape of the template region;
searching for an optimal template in a search region by using the template region and based on template matching, wherein the search region is defined within a reconstructed region of the current block; and
generating a prediction block of the current block from a reference block corresponding to the optimal template.

16. The method of claim 15, further comprising encoding the distance index.

17. A computer-readable recording medium storing a bitstream generated by a video encoding method, the video encoding method comprises:
determining a distance index (adjacent_idx) that indicates a distance between a current block and a template region;
determining the template region based on the distance between the current block and the template region, and a shape of the template region;
searching for an optimal template in a search region, by using the template region and based on template matching, wherein the search region is defined within a reconstructed region of the current block; and
generating a prediction block of the current block from a reference block corresponding to the optimal template.
